(19) United States
(12) Patent Application Publication
(10) Pub. No.: US 2012/0241018 A1
(43) Pub. Date: Sep. 27, 2012

(54) OVER-PRESSURE PROTECTION DEVICE

(76) Inventor: Bryan Alfano, Manchester, CT (US)

(21) Appl. No.: 13/070,342

(22) Filed: Mar. 23, 2011

(51) Int. Cl. F16K 17/04

(52) U.S. Cl. 137/115.16

(57) ABSTRACT

An over-pressure protection device has a valve or valve body defining an inlet, a first flow path or cavity, and an outlet. A moveable member or plunger defines an internal flow path, and has at least one passage formed through a wall thereof. A sealing member forms a fluid-tight seal between the plunger and the valve, while a biasing member or spring acts between the valve and the plunger. The plunger is disposed within the first flow path of the valve and is movable between a closed position and an open position when exposed to pressurized fluid. In the closed position, the sealing member forms a seal between the plunger and the valve, preventing fluid communication between the inlet and the outlet, but does not form a seal when the device is in the open position, allowing fluid communication with the outlet. The plunger is biased by the biasing member toward the open position.

### FIELD OF THE INVENTION

The present invention relates to protection devices for components, and more particularly to devices for protecting components and gauges, from over-pressure damage.

### BACKGROUND INFORMATION

Gauges are, by their nature, exposed to varying degrees of pressure within the system of which they are a part. In some instances, a gauge designed for low pressure may be exposed to a high pressure that exceeds what the gauge was designed for. This can happen, for example, in the HVAC field, where a technician will temporarily attach a gauge to a number of different, perhaps unfamiliar, HVAC systems. This exposure to over-pressure often results in damage to the gauge itself, leaving an HVAC system or technician with a damaged and inaccurate gauge. The damaged gauge requires replacement, but in some instances an HVAC technician may not have a replacement gauge on hand, may not be prepared to replace the gauge, may not know that the gauge is broken and providing an inaccurate measurement, or may simply not have the time to replace the gauge. In these instances, the damaged gauge may go un-replaced and left attached to the system.

Accordingly, it is an object of the present invention to overcome one or more of the above-described drawbacks and/or disadvantages of the prior art.

### SUMMARY OF THE INVENTION

In accordance with a first aspect, a device for protecting a component from over-pressure comprising a valve defining an inlet, a first flow path, and an outlet; a plunger defining an internal flow path, and having at least one through passage formed in a wall of the plunger; a sealing member adapted for forming a fluid-tight seal between the plunger and the valve; and at least one biasing member acting between at least a portion of the valve and at least a portion of the plunger, the plunger is disposed within the internal flow path of the valve and is movable amongst a plurality of positions including a closed position and at least a partially open position when a pressure force is applied to the plunger; the sealing member (i) forms a fluid-tight seal between the plunger and the valve when the plunger is in a closed position, thereby preventing fluidic communication between the valve inlet and the valve outlet; and (ii) is spaced from the valve when the plunger is in the at least partially open position or otherwise does not form a seal between the plunger and the valve when the plunger is in an open position, wherein the first flow path, internal flow path and the at least one through-passage define a flow path between the valve inlet and the valve outlet, thereby allowing fluid communication between the valve inlet and the valve outlet; is biased by the at least one biasing member toward the at least a partially open position.

In some embodiments of the present invention, the biasing member comprises at least one spring configured to be compressed between the at least a portion of the valve and the at least a portion of the plunger. In some embodiments, the sealing member is an o-ring. Preferably, some embodiments of the present invention further include a plurality of secondary sealing members. In such embodiments, the plurality of secondary sealing members form a fluid-tight pressure restricted chamber, and the at least one biasing member is located within the fluid-tight pressure restricted chamber.

In some embodiments, the at least one biasing member is selected based on an inherent biasing force of the at least one biasing member, the inherent biasing force correlating to a desired maximum pressure allowance for the device.

In some embodiments of the present invention, the plunger is permanently disposed within the first flow path defined by the valve. In other embodiments, the plunger is removably disposed within the first flow path defined by the valve. In such other embodiments, the invention further includes a snap ring connectable to the valve, wherein the snap ring retains the plunger within the valve.

In some embodiments of the present invention, the valve is associated with an HVAC pressure gauge. Some such embodiments include a manifold, wherein the HVAC gauge is mounted on the manifold. In such embodiments, the HVAC gauge is a low-pressure gauge, while in other such embodiments the HVAC gauge is a high-pressure gauge. In such embodiments, the HVAC gauge is an analog gauge, while in other such embodiments the HVAC gauge is a digital gauge.

In some embodiments, the plunger is made of brass.

In accordance with another aspect, the present invention is directed to a device for protecting a component from over-pressure, comprising a manifold having at least one valve; the valve defining an inlet, a first flow path, and an outlet; a plunger defining an internal flow path, and having at least one through passage formed in a wall of the plunger; a sealing member adapted for forming a fluid-tight seal between the plunger and the valve; and at least one biasing member acting between at least a portion of the valve and at least a portion of the plunger, the at least one spring configured to be compressed between the at least a portion of the valve and the at least a portion of the plunger; the plunger is disposed within the internal flow path of the valve and is movable amongst a plurality of positions including a closed position and at least a partially open position when a pressure force is applied to the plunger; the sealing member (i) forms a fluid-tight seal between the plunger and the valve when the plunger is in a closed position, thereby restricting fluidic access to the outlet; and (ii) does not form a seal between the plunger and the valve when the plunger is in an open position, thereby allowing fluidic access to the outlet; the plunger is biased by the at least one biasing member toward the at least a partially open position.

In accordance with another aspect, the present invention is directed to a device for protecting a component from over-pressure, comprising a valve including a valve body defining an inlet, an outlet, and a cavity between the inlet and the outlet defined by at least one wall of the valve body; and a movable member at least partially located within the cavity and movable amongst a plurality of positions including an at least partially open position and a closed position; when in the at least partially open position the movable member is spaced from the at least one wall of the valve body and defines at least a portion of a flow path between the valve inlet and the valve outlet, and the valve inlet and the valve outlet are in fluid communication with each other; when in the closed position the movable member sealingly engages the at least one wall of the cavity of the valve body and forms a seal therewith, preventing fluid communication between the valve inlet and the valve outlet; and when a fluid pressure at the valve inlet is below a pressure threshold, the movable member is in the at least partially open position, and when a fluid pressure at the valve inlet exceeds said pressure threshold, said pressure moves the movable member from the at least partially open position to the closed position.

In some embodiments of the present invention, when a fluid pressure drops below the threshold pressure, the movable member moves to the at least partially open position. Some embodiments include a biasing member for biasing the movable member toward the at least partially open position with a maximum biasing force about equal to a force exerted on the movable member by a fluid at said valve inlet at a pressure equal to the pressure threshold. In further embodiments, at least one secondary sealing member prevents fluid communication between the valve inlet and the at least one biasing member. In some embodiments, the sealing member is an o-ring.

In some embodiments of the present invention, the plunger is permanently disposed within the first flow path defined by the valve. In other embodiments, the plunger is removably disposed within the first flow path defined by the valve. In such other embodiments, the invention further includes a snap ring connectable to the valve, wherein the snap ring retains the plunger within the valve.

In some embodiments of the present invention, the manifold is an HVAC manifold. In such embodiments, the valve may be a low pressure valve, a high pressure valve, a vacuum pump valve, or a refrigerant cylinder valve. Some of such embodiments further include an HVAC gauge mounted on the manifold. In such embodiments, the HVAC gauge is a low-pressure gauge, while in other such embodiments the HVAC gauge is a high-pressure gauge. In such embodiments, the HVAC gauge is an analog gauge, while in other such embodiments the HVAC gauge is a digital gauge. In some embodiments, the plunger is made of brass.

In accordance with another aspect, a device for protecting a component from over-pressure, comprises first means for regulating fluid communication between an inlet and an outlet of the first means; second means at least partially located within the first means for selectively preventing fluid communication between the inlet and the outlet and for moving amongst a plurality of positions including (i) an at least partially open position when a fluid pressure to which the second means is exposed is less than a threshold pressure and in which the inlet and outlet are in fluid communication via a space defined between the first means and the second means and (ii) a closed position when a fluid pressure to which the second means is exposed is greater than the threshold pressure and in which the inlet and outlet are not in fluid communication; third means for forming a seal between the first means and second means in the closed position and thereby preventing fluid communication between the inlet and the outlet; and fourth means for biasing the second means toward the at least partially open position. In some such embodiments, the first means is a valve body defining a valve inlet, a valve outlet and a cavity therebetween; the second means is a plunger, the third means is an o-ring retained by one of the first means and the second means; and/or the fourth means is a spring.

One advantage of the present invention is that it protects a component, such as an HVAC or other gauge, from over-pressure damage. Another advantage is that an HVAC technician, or other technician operating pressure gauges, will not need to replace a gauge or other component in the field due to pressure damage, as the gauge is now protected from such damage. Yet another advantage is that gauges or components will not be damaged unknowingly, providing an inaccurate reading assumed to be accurate or improper functioning of the system. Therefore, an HVAC technician does not have to worry about over-pressure damage providing an inaccurate reading.

Other objects and advantages of the present invention and/or of the currently preferred embodiments thereof will become more readily apparent in view of the following detailed description and accompanying drawings.

### BRIEF DESCRIPTION OF THE DRAWINGS

FIG. 1 is a front perspective view of a manifold system including a manifold and two analog gauges.

FIG. 2 is a front perspective view of a low-pressure analog gauge.

FIG. 3 is a front elevational view of the low-pressure analog gauge of FIG. 2.

FIG. 4 is a partial cross-sectional view taken along line A-A of FIG. 2 showing an embodiment of the present invention.

FIG. 5 is a second partial cross-sectional view taken along line A-A of FIG. 2 showing the over-pressure device of an embodiment of the present invention.

FIG. 6 is a third partial cross-sectional view taken along line A-A of FIG. 2 showing the valve and the over-pressure device of an embodiment of the present invention in an open position.

FIG. 7 is a fourth partial cross-sectional view taken along line A-A of FIG. 2 showing the valve and the over-pressure device of FIG. 6 in a closed position.

### DETAILED DESCRIPTION OF EMBODIMENTS OF THE INVENTION

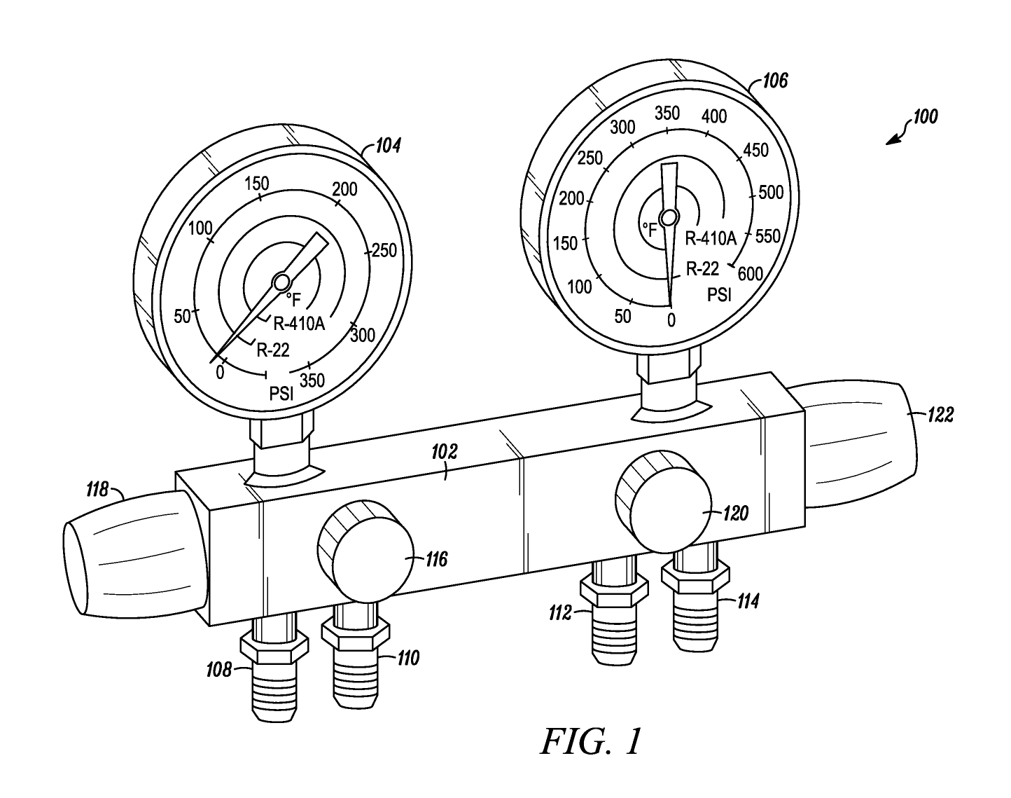

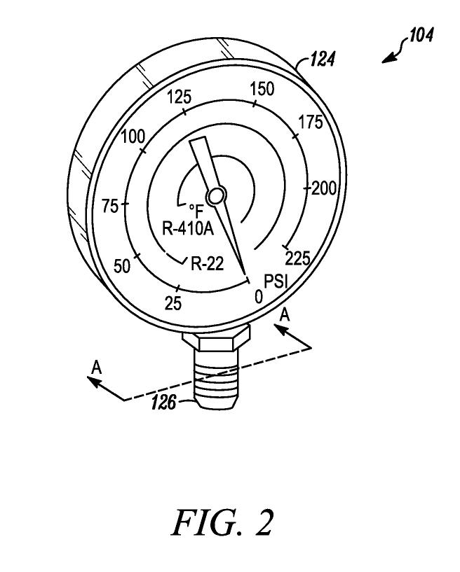

In FIG. 1, a manifold system for monitoring characteristics or physical properties of a system, such as an HVAC system, is indicated generally by the reference numeral 100. The HVAC manifold system 100 includes a HVAC manifold chamber 102, a low-pressure analog gauge 104, shown in greater detail in FIG. 2, and a high-pressure analog gauge 106. The low-pressure analog gauge 104 and the high-pressure analog gauge 106 display the monitored characteristics or physical properties of the respective HVAC system, such as pressure (e.g., system pressure), temperature (e.g., refrigerant temperature), or other measurable physical properties. The low-pressure analog gauge 104 and the high-pressure analog gauge 106 are connectable to the HVAC manifold chamber 102. In some embodiments, the low-pressure analog gauge 104 and the high-pressure analog gauge 106 are permanently affixed to the HVAC manifold chamber 102, while in other embodiments, the low-pressure analog gauge 104 and the high-pressure analog gauge 106 are removably attached to the manifold chamber 102. Removable attachment of the analog gauges 104, 106 can be achieved through any suitable means known in the art (e.g., threading). As shown in FIG. 1, the HVAC manifold chamber 102 includes four separate inlet valves protruding therefrom, including a low pressure inlet valve 108, a refrigerant cylinder inlet valve 110, a vacuum pump inlet valve 112, and a high pressure inlet valve 114. Further provided on the HVAC manifold chamber 102 are a plurality of handles or knobs, including a refrigerant cylinder valve knob 116, a low-pressure valve knob 118, a vacuum pump valve knob 120, and a high-pressure valve knob 122. Each handle or knob 116, 118, 120, 122 is for opening and closing their respective valves, placing the HVAC manifold chamber 102 and the analog gauges 104, 106 in fluid communication with the respective HVAC system. In some embodiments, the handles or knobs 116, 118, 120, 122 are torque limiting to form a secure fluid-tight seal between a respective sealing member (not shown) and HVAC system while substantially preventing damage to the sealing member by over-tightening.

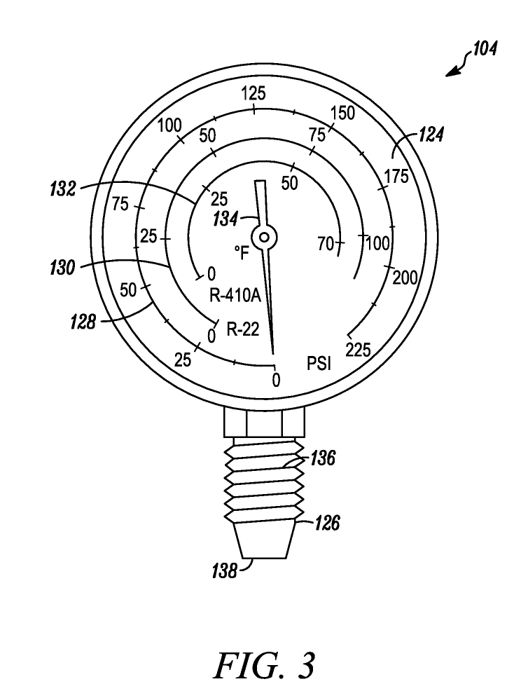

FIGS. 2 and 3 show the low-pressure analog gauge 104 of FIG. 1 in greater detail. Specifically, FIG. 2 is a perspective view of the low-pressure analog gauge 104, while FIG. 3 is a front elevational view of the low-pressure analog gauge 104. As shown in FIG. 2, the low-pressure analog gauge 104 includes, generally, a low-pressure analog gauge face 124 and a low-pressure analog gauge valve 126. Generally, the gauge face 124 provides a representation of the characteristics or physical properties of the respective HVAC system, while the gauge valve 126 allows for fluid communication with the respective HVAC system. As shown in FIG. 3, the gauge face 124 includes a plurality of scales, including, but not limited to, a PSI scale 128, a first refrigerant temperature scale 130 (e.g., R-22), and a second refrigerant temperature scale 132 (e.g., R-410A). The respective values of the system are indicated by an indicator needle 134. Importantly, as should be recognized by those of ordinary skill in the art, the gauge may be any type of gauge configured for any type of fluid, not just those measuring the characteristics of R-22 and R-410A. The low-pressure analog gauge 104 includes a gauge valve 126. The gauge valve 126, as shown in FIG. 3, includes a valve inlet 138, and external male threading 136 facilitating connection with the HVAC manifold chamber 102. It should be recognized by those of ordinary skill in the art that the external male threading 136 is not included in all embodiments as the low-pressure analog gauge 104 may be connected to the HVAC manifold chamber 102 through any suitable means known in the art.

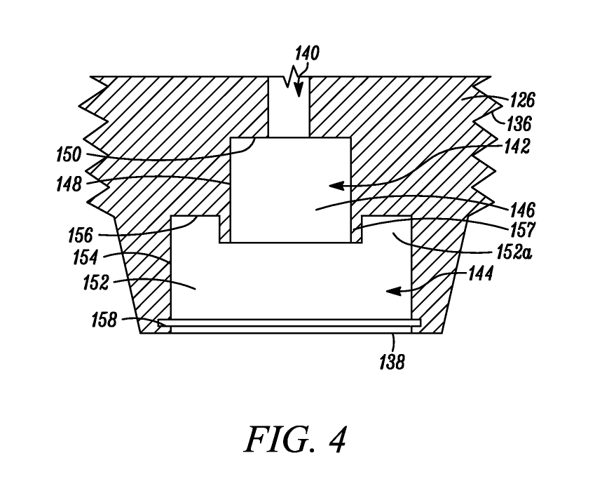

In FIG. 4, a partial cross-section of the gauge valve 126 of the present invention taken along line A-A of FIG. 2 is shown. The gauge valve 126 includes a valve body defining a valve inlet 138 disposed in an end thereof and further defines an internal cavity composed of a plurality of chambers and fluid pathways. Specifically, the internal cavity includes a valve outlet bore 140, first counter bore 142, and a second counter bore 144. The first counter bore 142 forms a first cylindrical wall 148 and a first end wall 150. The first counter bore 142 further defines a first cavity or void 146, which is also delineated by the first cylindrical wall 148 and the first end wall 150. The first counter bore 142 places the valve inlet 138 in fluidic communication with the valve outlet bore 140, defining a first flow path. This allows a fluid (e.g., R-22) to flow from the HVAC system, through the HVAC manifold chamber 102, through the valve inlet 138 and into the low-pressure analog gauge 104 for measurement. The second counter bore 144 forms a second cylindrical wall 154 and a second end wall 156. The second counter bore 144 further defines a second cavity or void 152, which is also delineated by the second cylindrical wall 154 and the second end wall 156. Also defined by the second counter bore 144 is an annular protrusion 157. The annular protrusion 157, second end wall 156 and portion of the second cylindrical wall 154 delineate a spring chamber 152a, which is a sub-chamber of the second void 152 and partially houses at least one spring 164 of an over-pressure protection device 160, discussed in greater detail below. The gauge valve 126 further includes an annular groove 158 formed therein for housing a snap-ring 166, discussed in greater detail below.

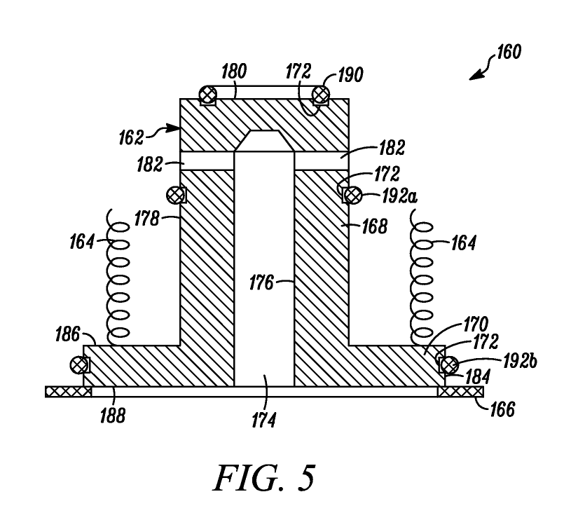

In FIG. 5, a partial cross-section of the over-pressure protection device 160 taken along line A-A of FIG. 2 is shown. The over-pressure protection device 160 includes a plunger 162, a biasing element 164, which in the illustrated embodiment comprises two springs, a snap-ring 166, a sealing member 190, a first secondary sealing member 192a, and a second secondary sealing member 192b. The plunger 162 is generally monolithic in form and includes a body 168 and an annular flange 170. In some embodiments, the plunger 162 is composed of brass. The body 168 defines an internal flow path 174 and includes an internal cylindrical body wall 176, an external cylindrical body wall 178, and an external end wall 180 opposite the flange 170. The body 168 further includes a plurality of through-passages 182, but in some embodiments there may be only one through-passage. The through-passages 182 extend through the body 168 from the internal cylindrical body wall 176 to the external cylindrical body wall 178, placing the internal flow path 174 in fluidic communication with the exterior of the plunger 162. The annular flange 170 includes an annular wall 184, an engagement surface 186 for engaging the springs 164, and a pressure surface 188. Regarding the springs 164, there are two springs illustrated in the over-pressure protection device 160, as shown in FIGS. 5, and 6-7. However, it should be understood that there is only one spring or other type of biasing member utilized in some embodiments. In some such embodiments, a singular spring coils around the body 168 of the plunger 162.

The plunger 162 further includes a plurality of annular notches 172 formed therein. Specifically, as shown in the exemplary embodiment of the present invention of FIG. 5, a first annular notch 172 is formed in the external end wall 180, a second annular notch 172 is formed in the exterior cylindrical body wall 178, and a third annular notch 172 is formed in the annular wall 184 of the annular flange 170. The first annular notch 172 retains the sealing member 190, which acts to form a fluid-tight seal between the plunger 162 and the first end wall 150 when in contact therewith, as discussed further below. The second annular notch 172 retains a first secondary sealing member 192a, which acts to form a fluid-tight seal between the plunger 162 and the first cylindrical wall 148. The third annular notch 172 retains a second secondary sealing member 192b, which acts to form a fluid-tight seal between the plunger 162 and the second cylindrical wall 154. The fluid-tight seal formed by the first and second secondary sealing members 192a, 192b isolate a portion of the second void 152 from fluid and pressure creating a un-pressurized chamber 152a for the springs 164. In some embodiments, the sealing member 190 and the first and second secondary sealing members 192a, 192b are an o-ring. However, as should be recognized by those of ordinary skill in the pertinent art, the sealing member 190 and the first and second secondary sealing members 192a, 192b may be any one of numerous different devices capable of forming a fluid-tight seal. In addition, it should be recognized that while in the illustrated embodiment the sealing member 190 and secondary sealing members 192a, 192b are associated with the plunger 162, in other embodiments one or more of the sealing member and secondary sealing member(s) are associated with or retained by the valve instead of the plunger.

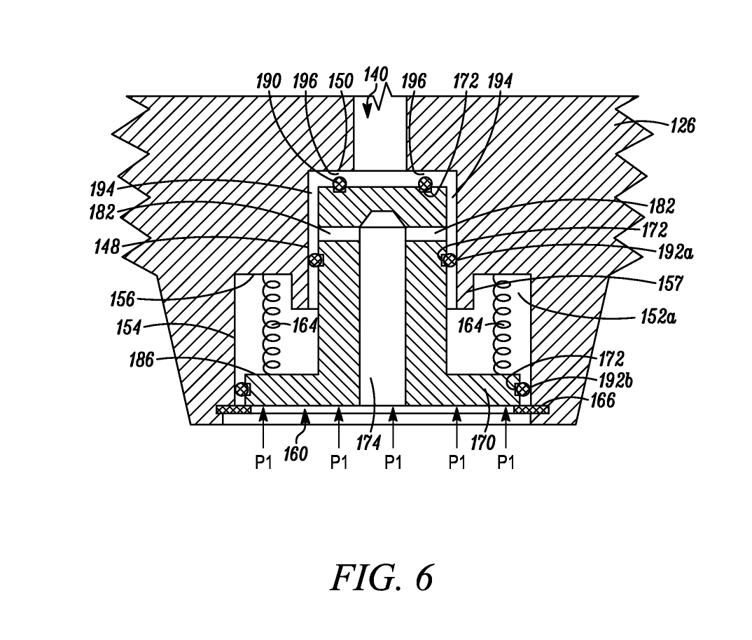

FIG. 6 is a partial cross-sectional view taken along line A-A of FIG. 2 showing the gauge valve 126 and the over-pressure protection device 160 in an “open” position. As shown, the over-pressure protection device 160 is inserted into the gauge valve 126, wherein the body 168 is located partially in the first void 146 and partially in the second void 152, and the annular flange 170 is located in the second void 152. When the over-pressure protection device 160 is fully installed in the gauge valve 126, the snap-ring 166 is inserted and snapped into the annular groove 158. When snapped into place, the snap-ring 166 acts to retain the over-pressure protection device 160 within the gauge valve 126, with the springs 164 biasing the plunger 162 toward an at least partially “open” position away from the end wall 150 toward the snap-ring 166. Each spring 164 engages the spring engagement surface 186 and the second end wall 156. The engagement of each spring 164 with the spring engagement surface 186 and the second end wall 156 forces the plunger 162 toward the valve inlet 138 and against the snap-ring 166, biasing the plunger 162 toward an at least partially “open” position. The first secondary sealing member 192a is dimensioned to sealingly engage the first cylindrical wall 148, and in the illustrated embodiment is compressed between the first cylindrical wall 148 and the body 168 forming a fluid-tight seal and restricting any fluid from the flow path 174 from coming in contact with the springs 164. Similarly, the second secondary sealing member 192b sealingly engages the second cylindrical wall 154, and, as illustrated in FIG. 6, is compressed between the second cylindrical wall 154 and the annular flange 170 forming a fluid-tight seal and restricting any fluid from the valve inlet 138 from coming in contact with the springs 164. The first and second secondary sealing members 192a, 192b, first cylindrical wall 148, second cylindrical wall 154, and plunger 162, create a fluid-tight and pressure-tight chamber for the springs 164, thus preventing corrosion or interfering with the functioning of the springs.

As shown in FIG. 6, when the over-pressure protection device 160 is fully retained in the valve 126, and the over-protection device 160 is in an at least partially “open” position, a second flow path 194 is defined between the first cylindrical wall 148 and the external cylindrical body wall 178. In the illustrated embodiment, the second flow path 194 is achieved by the first cylindrical wall 148 being diametrically larger than the diametrical extent of the external cylindrical wall 178. In other embodiments, the second flow path 194 is created by grooves, channels or recesses in the external cylindrical wall 178. Further, when the over-pressure protection device 160 is in the at least partially “open” position, a planar channel 196 is formed between the sealing member 190 and the first end wall 150. The planar channel 196 places the valve outlet bore 140 in fluidic communication with the valve inlet 138 via the internal flow path 174, passages 182, second flow path 194 and planar channel 196.

As indicated in FIG. 6, during operation, fluid flows in the direction of arrows P1 and generates pressure in the direction of arrows P1. Specifically, the pressure of the fluid is exerted against the pressure surface 188 of the annular flange 170, and generates force against the plunger 162 generally due to the differential surface area of the pressure surface 188 and the external end wall 180. This force is resisted by the compression force of the springs 164. If the force against the over-pressure protection device 160 does not overcome the spring force of the springs 164, then the over-pressure protection device 160 remains in an at least partially “open” position with the sealing member 190 spaced from the first end wall 150, as shown in FIG. 6. In the at least partially “open” position, fluid can pass from the valve inlet 138, into the internal flow path 174, through the through-passages 182, along the second flow path 194, across the planar channel 196, and out the valve outlet bore 140 to the low-pressure analog gauge 104, where the fluid pressure is measured.

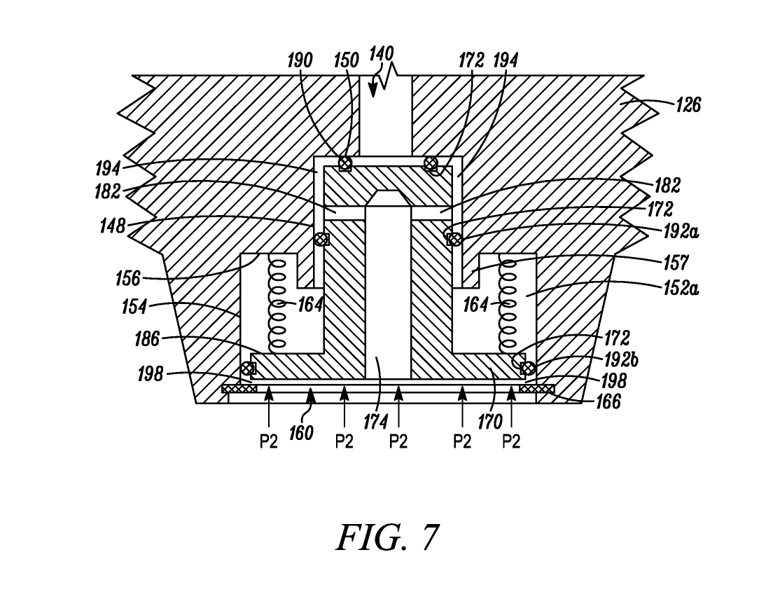

However, if the fluid pressure force exceeds the spring force of the springs 164, then the plunger 162 is forced toward the first end wall 150, compressing the springs 164, and into a “closed” position as shown in FIG. 7. In such a scenario, the springs 164 are compressed as the plunger 162, sealing member 190 and first and second secondary sealing members 192a, 192b are displaced toward the first end wall 150. This displacement causes the sealing member 190 to sealingly engage the first end wall 150, e.g., be compressed between the first end wall 150 and the body 168, creating a fluid-tight and pressure-tight seal between the plunger 162 and the first end wall 150. This restricts any further fluid and/or pressure from traveling through the valve outlet bore 140 and into contact with the pressure measuring device (not shown) contained within the low-pressure analog gauge 104. When the plunger 162 is displaced toward the “closed” position, an annular gap 198 is formed between the annular flange 170 and the snap-ring 166. When the fluid pressure is reduced to below the spring force, the springs 164 overcome the fluid pressure and force the plunger 162 back into the at least partially “open” position of FIG. 6, whereby fluid and pressure can travel freely from the valve inlet 138 to the valve outlet bore 140.

The forces exerted by the springs 164 determined at what pressure the device 160 closes. As one skilled in the art should understand, numerous springs are available with varying inherent spring constants or characteristics, and thus varying amounts of force (i.e., spring force) available. As such, the spring 164 is selected based on an allowable pressure for a gauge. For instance, if a maximum allowable gauge pressure is 400 PSI, then a spring should be chosen that will be overcome by a pressure of 400 PSI when it is applied to the gauge, and thus will be adequately compressed to allow closure of the device 160 by a pressure of 400 PSI. As noted above, the effective area to which the pressure is being applied to (e.g., the area of the pressure surface 188 and the portion(s) of the plunger 162 exposed to the pressure) determines the actual force acting against the spring 164, and the spring selection. As such, various springs can be employed and implemented in the present invention based on a maximum pressure allowance of the gauge.

In another embodiment of the present invention, the over-pressure protection device 160 may be incorporated in an HVAC manifold chamber 102 itself, rather than the valve of an HVAC gauge. For instance, the over-pressure protection device can be installed in any one of the low pressure valve 108, the refrigerant cylinder valve 110, the vacuum pump valve 112, or the high pressure valve 114 as shown in FIG. 1. In such embodiments, the over-pressure protection device 160 is configured, and functions, similarly to that shown in FIGS. 5-7, as above described. Similarly, it should be understood that the invention can be applied to and pertain to any gauge in which over-pressure protection is desired.

As may be recognized by those of ordinary skill in the pertinent art based on the teachings herein, numerous changes and modifications may be made to the above-described and other embodiments of the present invention without departing from its scope as defined in the appended claims. For example, the over-pressure protection device 160 may be used with any numerous different types of gauges that are currently known or that may later become known, including, for example, high-pressure gauges, digital pressure gauges, hybrid gauges or other types of gauges. Further, the application of the over-pressure protection device 160 is not limited to HVAC gauges and applications, but is applicable to other applications in which over-pressure protection is desired. Further, as mentioned above, the over-pressure-protection device 160 may be incorporated into the various pressure system components, as opposed to a gauge itself. In addition, the over-pressure protection device 160 may be secured in place in any of numerous different ways that are currently known or later become known. For example, the over-pressure protection device 160 may be removably secured in place by a removable snap-ring, as described above, or may be permanently secured in place by a permanent snap-ring, solder bead, weld (though still allowing displacement of the plunger), or any other manner that is currently known in the art or later becomes known. Accordingly, this detailed description of the currently preferred embodiments is to be taken in an illustrative as opposed to limiting sense.

What is claimed is:

1. A device for protecting a component from over-pressure, comprising:
a valve defining an inlet, a first flow path, and an outlet;
a plunger defining an internal flow path, and having at least one through-passage formed in a wall of the plunger in fluid communication with the internal flow path;
a sealing member adapted for forming a fluid-tight seal between the plunger and the valve; and
at least one biasing member acting between at least a portion of the valve and at least a portion of the plunger;
wherein the plunger is disposed within the internal flow path of the valve and is movable amongst a plurality of positions including a closed position and at least a partially open position when a pressure force is applied to the plunger;
wherein the first flow path, internal flow path and at least one through-passage define a flow path between the valve inlet and the valve outlet when the plunger is in the open position;
wherein the sealing member
(i) forms a fluid-tight seal between the plunger and the valve when the plunger is in the closed position, thereby preventing fluidic communication between the valve inlet and the valve outlet; and
(ii) is spaced from the valve when the plunger is in the at least partially open position and does not form a seal between the plunger and the valve, thereby allowing fluid communication between the valve inlet and the valve outlet; and
wherein the plunger is biased by the biasing member toward the at least a partially open position.

2. The device as defined in claim 1, wherein the at least one biasing member is compressible between the at least a portion of the valve and the at least a portion of the plunger

3. The device as defined in claim 1, wherein the sealing member is an o-ring.

4. The device as defined in claim 1, further including a plurality of secondary sealing members forming a seal between the plunger and the valve.

5. The device as defined in claim 4, wherein the plurality of secondary sealing members form a fluid-tight pressure restricted chamber, and the at least one biasing member is located within the fluid-tight pressure restricted chamber.

6. The device as defined in claim 1, wherein the at least one biasing member is selected based on an inherent maximum biasing force of the at least one biasing member, the inherent maximum biasing force correlating to a desired maximum pressure allowance for the device.

7. The device as defined in claim 1, wherein the plunger is permanently disposed within the first flow path defined by the valve.

8. The device as defined in claim 1, wherein the plunger is removably disposed within the first flow path defined by the valve.

9. The device as defined in claim 8, further including a snap ring connectable to the valve, wherein the snap ring retains the plunger within the valve.

10. The device as defined in claim 1, wherein the valve is associated with an HVAC pressure gauge.

11. The device as defined in claim 10, further including a manifold, wherein the HVAC gauge is mounted on the manifold.

12. The device as defined in claim 10, wherein the HVAC gauge is a low-pressure gauge.

13. The device as defined in claim 10, wherein the HVAC gauge is a high-pressure gauge.

14. The device as defined in claim 10, wherein the HVAC gauge is an analog gauge.

15. The device as defined in claim 10, wherein the HVAC gauge is a digital gauge.

16. The device as defined in claim 1, further including external male threading disposed on the valve for attachment to a manifold.

17. The device as defined in claim 1, wherein the plunger is made of brass.

18. A device for protecting a component from over-pressure, comprising:
a valve including a valve body defining an inlet, an outlet, and a cavity between the inlet and the outlet defined by at least one wall of the valve body; and
a movable member at least partially located within the cavity and movable amongst a plurality of positions including an at least partially open position and a closed position;
wherein when in the at least partially open position the movable member is spaced from the at least one wall of the valve body and defines at least a portion of a flow path between the valve inlet and the valve outlet, and the valve inlet and the valve outlet are in fluid communication with each other;
wherein when in the closed position the movable member sealingly engages the at least one wall of the cavity of the valve body and forms a seal therewith, preventing fluid communication between the valve inlet and the valve outlet; and
wherein when a fluid pressure at the valve inlet is below a pressure threshold, the movable member is in the at least partially open position, and when a fluid pressure at the valve inlet exceeds said pressure threshold, said pressure moves the movable member from the at least partially open position to the closed position.

19. The device as defined in claim 18, wherein when a fluid pressure drops below said pressure threshold, the movable member moves to the at least partially open position.

20. The device as defined in claim 18, further comprising a biasing member configured to bias the movable member toward the at least partially open position with a maximum biasing force substantially equal to a force exerted on the movable member by a fluid at said valve inlet at a pressure equal to said pressure threshold.

21. The device as defined in claim 20, further comprising at least one secondary sealing member preventing fluid communication between the valve inlet and the at least one biasing member.

22. The device as defined in claim 18, further comprising at least one internal passage through the movable member defining at least a portion of the flow path between the valve inlet and the valve outlet.

23. The device as defined in claim 18, further comprising at least one sealing member adapted for forming the seal between the movable member and the at least one wall of the cavity when the movable member is in the closed position.

24. The device as defined in claim 18, wherein the valve inlet is in fluid communication with a pressure manifold.

25. A device for protecting a component from over-pressure, comprising:
first means for regulating fluid communication between an inlet and an outlet of the first means;
second means at least partially located within the first means for selectively preventing fluid communication between the inlet and the outlet and for moving amongst a plurality of positions including (i) an at least partially open position when a fluid pressure to which the second means is exposed is less than a threshold pressure and in which the inlet and outlet are in fluid communication via a space defined between the first means and the second means and (ii) a closed position when a fluid pressure to which the second means is exposed is greater than the threshold pressure and in which the inlet and outlet are not in fluid communication;
third means for forming a seal between the first means and second means in the closed position and thereby preventing fluid communication between the inlet and the outlet; and
fourth means for biasing the second means toward the at least partially open position.

26. The device as defined in claim 25, wherein the first means is a valve body defining the valve inlet, the valve outlet and a cavity therebetween; the second means is a plunger, the third means is an o-ring retained by one of the first means and the second means; and the fourth means is a spring.
